(19) United States
(12) Patent Application Publication
(10) Pub. No.: US 2017/0077560 A1
(43) Pub. Date: Mar. 16, 2017

(54) WIRELESS MONITOR FOR DETECTING AND INDICATING A CONDITION OF A BATTERY

(71) Applicant: Powerhouse Electronics Corp., Sterling Heights, MI (US)

(72) Inventors: James Ernest Kemp, Troy, MI (US); Mark Evan Metcalf, Rochester Hills, MI (US)

(21) Appl. No.: 15/262,432

(22) Filed: Sep. 12, 2016

Related U.S. Application Data
(60) Provisional application No. 62/217,602, filed on Sep. 11, 2015.

(51) Int. Cl. H01M 10/42; H01M 10/48

(52) U.S. Cl. CPC H01M 10/4285; H01M 10/4257; H01M 10/484; H01M 10/486; H01M 10/488; H01M 10/48; H01M 2010/4278; H01M 2220/10; H01M 2220/20; H01M 2220/30

(57) ABSTRACT

A wireless condition monitor includes a sensor device and a transceiver device for detecting and indicating conditions of an industrial battery. The sensor device includes a sensing element configured to detect a condition of the industrial battery and a wireless transmitter configured to wirelessly transmit a signal indicative of the condition. The transceiver device is in communication with the sensor device and includes a signal indicator configured to indicate receipt of the signal from the sensor device. The sensor device can be removably coupled to an inspection port or sensor-specific mounting of the industrial battery, or permanently disposed within a chamber of the industrial battery.

### CROSS REFERENCE TO RELATED APPLICATIONS

This disclosure claims the benefit of U.S. Provisional Application No. 62/217,602, filed Sep. 11, 2015, entitled “Wireless Condition Monitor for Industrial Battery,” the disclosure of which is herein incorporated by reference.

### TECHNICAL FIELD

This disclosure relates in general to a wireless monitor for detecting and indicating a condition of a battery.

### BACKGROUND

Some batteries, such as those that power commercial or industrial machinery, use an electrolyte solution to maintain a constant electrical output. The health of such batteries can be maintained by monitoring the volume of the electrolyte solution, for example, to prevent the volume from reaching a level detrimental to the battery. Conventional monitors for such electrolyte solution volumes are hardwired to a subject battery and include a signaling mechanism for indicating when the volume reaches a detrimental level. However, the positioning of the monitor with respect to the battery can make it difficult to observe such indications from the signaling mechanism. Furthermore, the installation of such conventional monitors is complicated by a risk of exposure to dangerous chemical agents within the battery.

### SUMMARY

Disclosed herein are implementations of wireless monitors for detecting and indicating conditions of batteries.

In an implementation, a wireless monitor is provided for detecting and indicating conditions of a battery. The wireless monitor comprises a sensor device and a transceiver device. The sensor device is coupled to the battery and includes a sensing element that detects a condition of the battery and a wireless transmitter that wirelessly transmits a signal indicative of the condition. The transceiver device is in communication with the wireless transmitter of the sensor device and includes a signal indicator that indicates the signal indicative of the condition responsive to receiving the signal from the wireless transmitter of the sensor device.

In an implementation, a method is provided for using a wireless monitor to detect and indicate conditions of a battery. The method comprises detecting a condition of a battery using a sensing element of a sensor device, the sensing element contacting at least a portion of the battery. The method further comprises generating a signal indicative of the condition using a processor of the sensor device. The method further comprises wirelessly transmitting the signal to a transceiver device using a wireless transmitter of the sensor device. The method further comprises indicating the signal using a signal indicator of the transceiver device.

In an implementation, a system is provided for wirelessly monitoring conditions of batteries. The system comprises a battery, a sensor device, and a transceiver device. The includes a chamber storing a volume of an electrolyte solution and is usable to power machinery. The sensor device is coupled to the battery and includes a body, an elongate shaft coupled to the body, at least one sensing element, and a wireless transmitter. The transceiver device includes a communication component and at least one signal indicator. The wireless transmitter wirelessly transmits at least one of a first signal based on the volume of the electrolyte solution within the chamber of the battery, a second signal based on a temperature of the battery, or a third signal based on a motion of the battery. The at least one sensing element is at least one of a contact closure probe, a temperature sensor, or an accelerometer. The communication component is in communication with the wireless transmitter of the sensor device and receives at least one of the first signal, the second signal, or the third signal from the sensor device. The at least one signal indicator indicates the at least one of the first signal, the second signal, or the third signal using at least one indicator configuration associated with the at least one of the first signal, the second signal, or the third signal.

These and other aspects of this disclosure are disclosed in the following detailed description, the appended claims, and the accompanying figures.

### BRIEF DESCRIPTION OF THE DRAWINGS

The description herein makes reference to the accompanying drawings wherein like reference numerals refer to like parts throughout the several views.

FIG. 1 is an illustration of an example of a sensor device of a wireless monitor for detecting a condition of a battery.

FIG. 2 is an illustration of an example of a transceiver device of a wireless monitor for indicating a condition of a battery.

FIG. 3 is an illustration a battery including a wireless monitor for detecting and indicating a condition of the battery.

FIG. 4 is a block diagram of an example of a circuit of a microprocessor of a wireless monitor.

FIG. 5 is a flowchart illustrating an example of a method for detecting a condition of a battery using a wireless monitor.

### DETAILED DESCRIPTION

A wireless monitor is herein disclosed for detecting and indicating conditions of a battery to which at least a portion of the wireless monitor is coupled. The wireless monitor can generally be used with any battery including an electrolyte solution stored in a chamber, for example, batteries used to power commercial or industrial machinery, such as forklift machines and other vehicles. The wireless monitor is configured to detect a variety of distinct conditions of a battery, including without limitation a volume of electrolyte solution, a temperature, or a motion of the battery.

The wireless monitor is further configured to wirelessly transmit a signal indicative of the detected conditions for observation. For example, a transceiver of the wireless monitor can wirelessly receive a signal generated by a sensor of the wireless monitor. The transceiver can operate in a location proximate to or distant from the sensor, subject to limitations of applicable wireless communication technology. Implementations of the wireless monitor can detect and indicate maintenance-related, operation-related, or other conditions of the battery for convenient observation without interfering with the operation of the wireless monitor, the battery to which the wireless monitor is coupled, or the machinery powered by the battery.

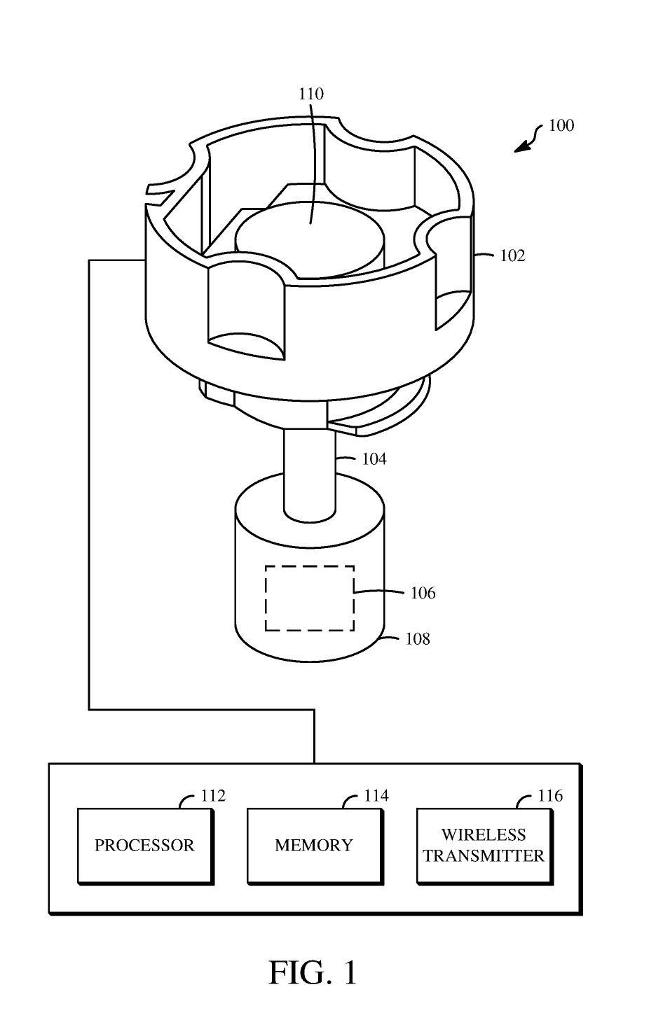

FIG. 1 is an illustration of an example of a sensor device 100 of a wireless monitor for detecting a condition of a battery. The sensor device 100 includes a body 102 and an elongate shaft 104. A sensing element 106 is disposed about the elongate shaft 104 at an end of the elongate shaft 104 that is distal to the body 102. The sensing element 106 is configured to contact a portion of a battery (not shown) to which the sensor device 100 is coupled in order to monitor one or more conditions of the battery.

In some implementations, the sensing element 106 can be a temperature sensor that can detect a temperature of the battery. For example, when the temperature of the battery reaches an operating temperature falling outside of a specified safe range, the temperature sensor can detect a condition indicating that the industrial battery is operating at a potentially dangerous temperature. In some implementations, the sensing element 106 can be an accelerometer that can detect a motion of the battery. For example, when the battery experiences movement in any direction, the accelerometer can detect a condition indicating the battery is in motion.

In some implementations, the sensing element 106 can be a contact closure probe that can use conductive actuation to detect a volume of a solution stored within a battery (e.g., an electrolyte solution stored in a chamber of the battery). For example, the contact closure probe can be a plurality of conductive (e.g., lead) electrodes that use conductive actuation to detect a volume of the solution. In another example, the contact closure probe can be a magnetic element that uses conductive actuation to detect a volume of the solution by floating on the solution. When a volume of the solution reaches a level that poses a risk of harm to the battery, the contact closure probe can detect a condition indicating the dangerous level of the solution.

Other configurations of the sensing element 106 are possible. For example, in some implementations, the sensing element 106 can include sensors for measuring electrolyte-specific gravity or cell voltage for the battery. In another example, in some implementations, the sensing element 106 can include a combination of the foregoing.

In some implementations, the elongate shaft 104 can include a housing 108 within which the sensing element can be disposed. The housing 108 can protect the sensing element 106 from exposure to materials of the battery that might otherwise damage the sensing element 106. For example, the housing 108 can be comprised of a material resistant to or otherwise capable of withstanding contact by sulfuric acid or other chemical agents of the battery. In some implementations, the housing 108 can support the sensing element 106 in an operation position to detect a condition of the battery.

For example, where the sensing element 106 is a contact closure probe (e.g., a magnetic element), the housing 108 can support the contact closure probe in a position relative to the body 104 based on a volume of the solution stored in the chamber of the battery. In the event that the volume of the solution decreases, the housing 108 can slidably descend along the elongate shaft 104 to move the contact closure probe farther away from the body 102. The sensor device 100 can detect a condition indicating that the volume of solution within the battery has reached a detrimental level upon the contact closure probe moving beyond a threshold distance from the body 102. In some implementations, the threshold distance can be indicative of a minimum volume of solution at which the battery is capable of operating without risk of breakdown. In some implementations, the threshold distance can be another position of the contact closure probe along the elongate shaft 104 defined by a user of the sensor device 100.

In some implementations, the sensor device 100 can include a power source 110. The power source 110 can be any component capable of powering the sensor device 100 without interfering with the ability of the sensor device 100 to detect conditions of a battery. For example, the power source 110 can be a battery, including, without limitation, a low voltage coin cell battery. In some implementations, the power source 110 can have a long lifetime relative to an operational lifetime of the sensor device 100. For example, in some implementations where the sensor device 100 is permanently disposed within a chamber of the battery, the power source 110 can have an operational lifetime that meets or exceeds that of the battery in order to power the sensor device 100 for the duration of the lifetime of the battery.

In some implementations, the sensor device 100 can include a cover (not shown) coupled to an end of the body 102 distal to the elongate shaft 104. The cover can protect interior components of the body 102 from materials or elements not intended to enter the body 102, for example, dust, liquids, or the like. The cover can be removably coupled to the body 102 (e.g., via a snap-lock, friction fit, threaded, or other engagement), or permanently coupled to the body. A removable coupling of the cover to the body 102 can allow for convenient access to, and maintenance of, the interior components of the body 102, for example, to replace the power source 110.

The interior components of the body 102 can include components used to process data for detecting conditions of a battery using the sensing element 106. As shown in the figure, the body 102 includes a processor 112, a memory 114, and a wireless transmitter 116. The processor 112 is a central processing unit (CPU) that processes instructions stored in the memory 114 using one or more cores. In some implementations, the CPU 112 can be a microprocessor. In some implementations, the processor 112 can be any other type of device, or multiple devices, that manipulate or process data, now-existing or hereafter developed. Although the implementations of the sensor device 100 can be practiced using a single processor 112 as shown, advantages in speed and efficiency can be achieved using more than one processor 112.

The memory 114 can be a random access memory (RAM) device or any suitable type of non-transitory storage device, for example, a disk drive or solid state drive. In some implementations, the memory 114 can store instructions executable by the processor 112 that, when executed by the processor 112, cause the sensor device 100 to detect a condition of a battery and process data indicative of the detected condition (e.g., by transmitting the data using the wireless transmitter 116). For example, the instructions can represent a computer program product executable by the processor 112 to detect a condition of the battery and transmit a signal indicative of the condition using the wireless transmitter 116. The instructions can be developed using any programming language suitable for commanding components of the sensor device 100, for example, C, Python, or the like.

The wireless transmitter 116 wirelessly transmits a signal indicative of a condition of the battery detected using the sensing element 106, which signal is generated by the processor 112 based on an execution of the instructions stored in the memory 114. In some implementations, the wireless transmitter 116 can be or include a radio transmitter for enabling radio frequency transmission from the sensor device 100. In some implementations, the wireless transmitter 116 can be or include one or more network interface components for enabling transmission over IEEE 802 protocols (e.g., 802.15.4), Wi-Fi, Bluetooth, near field communications, GSM, CDMA, or the like.

As such, the signal can be of any transmission type that enabled by the wireless transmitter 116. In some implementations, the signal can be indicative of a single condition of the battery. In some implementations, the signal can be indicative of a plurality of conditions of the battery. In some implementations, the signal can include first data indicative of the applicable one or more conditions as well as second data associated with the one or more conditions, for example, which second data can be used to uniquely indicate the conditions by another device that receives the signal from the wireless transmitter 116.

In some implementations, the memory 114 can include instructions that, when executed by the processor 112, cause the processor 112 to generate record data indicative of the detected one or more conditions of the battery. For example, the record data can include data representing whether a detected condition poses a risk of harm to the battery, a date or timestamp indicating the date on or time at which the condition is detected by the sensing element 106 or transmitted by the wireless transmitter 116, a cardinality of conditions detected at a given instance of detection, a number of times the detected condition has been detected by the sensor device 100, other information useful for the maintenance of the battery to which the sensor device 100 is coupled, or a combination of the foregoing.

The wireless transmitter 116 can transmit the record data to a computing device, for example, a desktop computer, laptop computer, tablet computer, smartphone, a server device, or other mobile or stationary computer. In some implementations, the computing device to which the record data is transmitted can store the record data in a repository, for example, a database. In some implementations, the wireless transmitter 116 can automatically transmit the record data to a default or pre-selected computing device upon a determination that the computing device is within a communicable range of the sensor device 100. In some implementations, the computing device to which the record data is transmitted can be configurably selected by a user of the sensor device 100. In some implementations, where the processor 112 is a microprocessor, the wireless transmitter 116 can be included in the microprocessor.

Configurations of the sensor device 100 other than those described above are also possible. For example, in some implementations, the sensor device 100 can include multiple sensing elements 106, such as a combination of a contact closure probe, a temperature sensor, an accelerometer, or the like. In some implementations, the sensing elements of the combination can be disposed within different portions of the sensor device. For example, the contact closure probe (e.g., a magnetic element) and the temperature sensor can both be disposed within the housing 108, while the accelerometer can be disposed within the body 102. In another example, the contact closure probe can be disposed within the housing 108, while the accelerometer and temperature sensor can both be disposed within the body 102. In another example, the processor 112 can generate a signal indicating that no dangerous or potentially harmful conditions are present with respect to the battery, such that signals can be indicative of conditions other than those that pose a risk of damage to the battery.

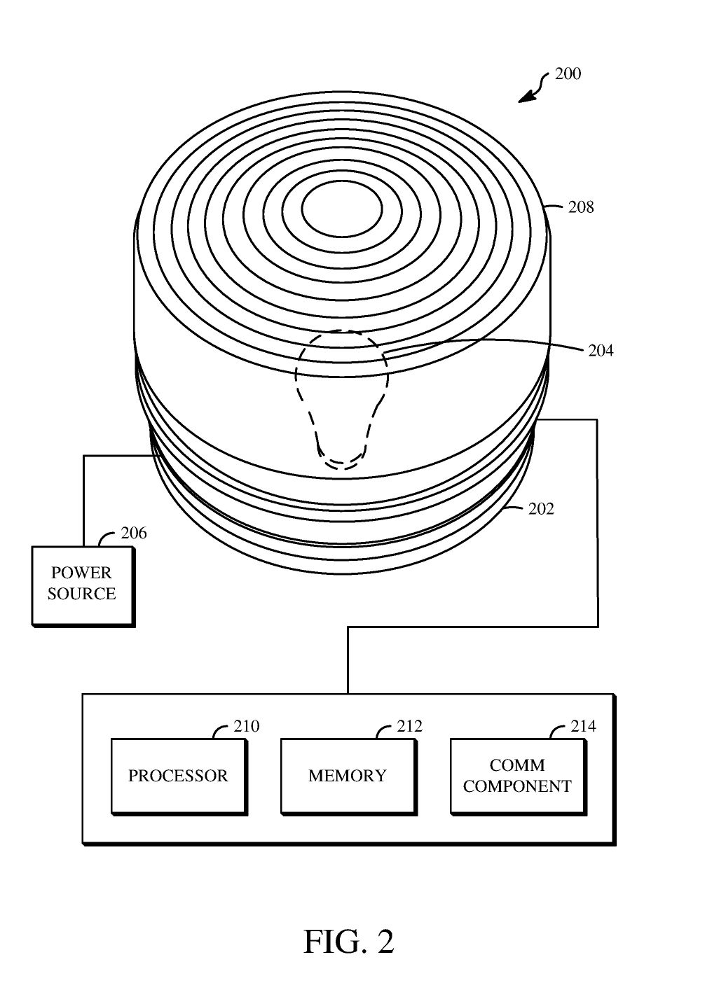

FIG. 2 is an illustration of an example of a transceiver device 200 of a wireless monitor for indicating a condition of a battery. The transceiver device 200 includes a base 202 and a signal indicator 204. The base 202 can be removably or permanent coupled to any surface. In some implementations, a separate attachment mechanism (not shown) may be included for coupling the base 202 to a surface. The signal indicator 204 is coupled to the base 202 and can indicate the receipt of a signal transmitted to the transceiver device 200, for example, by a wireless component 116 of a sensor device 100.

In some implementations, the signal indicator 204 can include a light source, for example, a conventional incandescent or fluorescent light bulb, a light emitting diode (LED), or the like. The light source can blink, flash, or otherwise indicate that a signal has been received by the transceiver device 200. For example, the light source can flash once or using a pattern, for example, periodically every three seconds or at varying-speeds over a defined signaling period. In some implementations, the light source can be configured to flash a different color or pattern based on a detected condition indicated by the signal. For example, the light source can flash a red light every two seconds to indicate that the received signal indicates a condition with respect to a volume of solution within the battery. In another example, the light source can blink a green light repeatedly to indicate that the received signal indicates a condition with respect to a motion of the battery. In some implementations, the intensity or frequency of blinks, flashes, or the like by the light source can indicate a severity of a detected condition indicated by the signal. In some implementations, the manner in which the light source can indicate particular conditions can be configured by a user of the transceiver device 200.

In some implementations, the signal indicator 204 can include a sound source, for example, a speaker or the like. The sound source can emit a noise to indicate that a signal has been received by the transceiver device 200. In some implementations, the sound source can be configured to emit distinct noises for different types of detected conditions indicated by a received signal. For example, a first noise can be a sound emitted constantly for five seconds to indicate that the received signal indicates a condition with respect to a temperature of the battery. In another example, a second noise can be a sound repeated every half second to indicate that the received signal indicates a condition with respect to cell voltage of the battery. In some implementations, the intensity or frequency of noises emitted by the sound source can indicate a severity of a detected condition indicated by the signal. In some implementations, the manner in which the sound source can indicate particular conditions can be configured by a user of the transceiver device 200.

In some implementations, the transceiver device 200 can include a power source 206. The power source 206 can be any component capable of powering the transceiver device 200 without interfering with the ability of the transceiver device 200 to indicate detected conditions of a battery. For example, the power source 206 can be a battery, including, without limitation, a low voltage coin cell battery. In some implementations, the transceiver device 200 can include a cover 208 coupled to the base 202. The cover 208 can protect interior components of the base 202 from materials or elements not intended to enter the base 202, for example, dust, liquids, or the like. The cover 208 can be removably coupled to the base 202 (e.g., via a snap-lock, friction fit, threaded, or other engagement), or permanently coupled to the body. A removable coupling of the cover to the body 202 can allow for convenient access to, and maintenance of, the interior components of the body 202, for example, to replace the signal indicator 204 or power source 206.

The interior components of the base 202 can include components used to process data for indicating conditions of a battery using the signal indicator 204. As shown in the figure, the base 202 includes a processor 210, a memory 212, and a communication component 214. The processor 210 can have implementations similar to the processor 112 of the sensor device 100. The memory 212 can have implementations similar to the memory 114 of the sensor device 100. However, in some implementations, the memory 212 can include instructions that, when executed by the processor 210, cause the processor 210 to identify an indication configuration associated with a detected condition and cause the signal indicator 204 to indicate the detected condition using the indication configuration. The indication configuration includes data indicating the manner in which to indicate the detected condition using the signal indicator 204. For example, the indication configuration can include data stored in the memory indicating how to operate a light source or sound source based on the particular condition that is indicated by the received signal.

The communication component 214 can receive a signal transmitted from the sensor device 100 (e.g., by the wireless transmitter 116). In some implementations, the operation of the communication component 214 can be configured using a computer program product comprising instructions stored in the memory 212. For example, those instructions, when executed by the processor 210, can cause the communication component 214 to automatically exit a wait state and listen for a signal from the sensor device 100 on a configurable interval period (e.g., once per fifteen second interval), and to automatically return to the wait state upon the expiration of the configurable interval period. Such operation can cause the transceiver 200 to be able to actively listening for signals from the sensor device 100 while preserving the power source 206. In another example, those instructions, when executed by the processor 210, can cause the communication component 214 to passively await a receipt of a signal transmitted from the sensor device 100 (e.g., by the wireless transmitter 116) instead of actively listening for signals transmitted thereby.

Configurations of the transceiver device 200 other than those described above are also possible. For example, in some implementations, the transceiver device 200 and the sensor device 100 can be integrated into a single monitor device (not shown). For example, the transceiver device 200 can be mounted on top of a cover of the body 102 of the sensor device 100. Other types of wireless communication between the wireless transmitter 116 of the sensor device 100 and the communication component 202 of the transceiver device can be enabled by the direct contacting of the sensor device 100 and the transceiver device, for example, using infrared, vibratory, pulse, or other wireless technologies. In another example, in some implementations, the signal indicator 204 can include both a light source and a sound source. In another example, in some implementations, the communication component 214 can receive record data generated by the sensor device 100 as an intermediary component and transmit the received record data to the computing device on which the record data is to be stored. In some implementations, the record data can be generated by the processor 210 of the transceiver device 200 based on instructions stored in the memory 212, rather than by a processor 112 of the sensor device 100. In another example, the signal indicator 204 can indicate a light, sound, or other feature upon the transceiver device 200 receiving a signal from the sensor device 100 indicating that no dangerous or potentially harmful conditions are present with respect to the battery.

Furthermore, in some implementations, the sensor device 100 and the transceiver device 200 can be incorporated as part of a security system for detecting and indicating security conditions of machinery including the battery to which the sensor device 100 is coupled. In some implementations, the security system can detect the unauthorized use of the machinery. For example, an accelerometer of the sensor device 100 can detect a motion of the machinery when the machinery is not authorized for use (e.g., after permitted use hours, by an operator of the machinery failing to enter valid security credentials for operating the machinery, or the like). In another example, a temperature sensor of the sensor device 100 can detect an increase in a temperature of the battery caused by such an unauthorized use. The sensor device 100 can transmit a signal indicative of the unauthorized use to the transceiver device 200. In some implementations, the sensor device 100 can also generate record data to record the instance of unauthorized use.

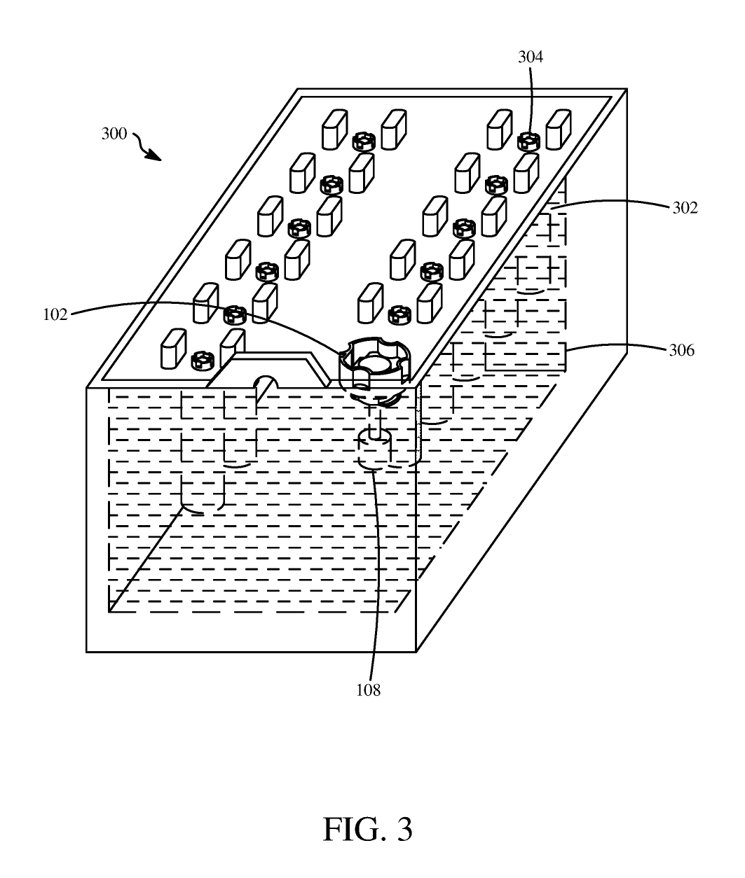

FIG. 3 is an illustration a battery 300 including a wireless monitor (the sensor device 100 and the transceiver device 200) for detecting and indicating a condition of the battery 300. The battery 300 can be any battery usable to power machinery. In some implementations, the battery 300 can include a number of ports 302 on a top or other surface thereof, which ports, when open, grant access to respective interior portions of the battery 300. A port 302 can be closed using a plug 304, which plug 304 can be removed when access to the respective interior portion of the battery 300 through the respective port 302 is desired. In some implementations, the port can be an inspection port or other port usable in connection with the maintenance or operation of the battery 300.

In some implementations, the sensor device 100 can be coupled to a port 302 of the battery 300. For example, a plug 304 of a port 302 can be removed such that the sensor device 100 can be coupled to the port 302. In this way, the elongate shaft 106 can extend downwardly from the port 302 into an interior portion of the battery, for example, a chamber 306 of the battery 300 that stores a solution 308, such as an electrolyte solution. The coupling of the sensor device 100 to a port 302 of the battery 300 can be via a removable configuration, for example, using a snap-lock, friction fit, threaded, or other engagement between the port 302 and a portion of the body lateral to the elongate shaft 104. The removable coupling of the sensor device 100 to a port 302 of the battery 300 allows for an easy installation of and maintenance to the sensor device 100 (e.g., to replace components thereof as they degrade).

In some implementations, the transceiver device 200 can also be coupled to the battery 300. For example, the transceiver device 200 can be coupled to a flat surface of the battery that is observable during the operation of the machinery without manual intervention. In another example, the transceiver device 200 can be coupled directly to the sensor device 100, for example, when a manner of wireless transmission of a signal involves communication over a short distance (e.g., where a vibratory signal is transmitted).

Configurations of the coupling between the wireless monitor and the battery 300 other than those described above are also possible. For example, in some implementations, the sensor device 100 can be permanently coupled to a port 302 of the battery 300 by welding a portion of the body 102 or a separate plate component (not shown) coupled to the body 102 of the sensor device 100 to the port 302. In another example, in some implementations, the sensor device 100 can be coupled to the battery 300 without using a port 302. For example, in some implementations, the sensor device 100 can be coupled to a sensor-specific mounting (not shown) affixed to or otherwise included about the battery 300, for example, an aperture drilled into the battery 300. In another example, the sensor device 100 can be permanently disposed within the chamber 306. In this way, the sensor device 100 can become inaccessible during the use of the battery 300. The sensor device 100 in those implementations can be comprised of a material or materials suitable for withstanding degradation or damage caused by the contents of the chamber 306 (e.g., sulfuric acid).

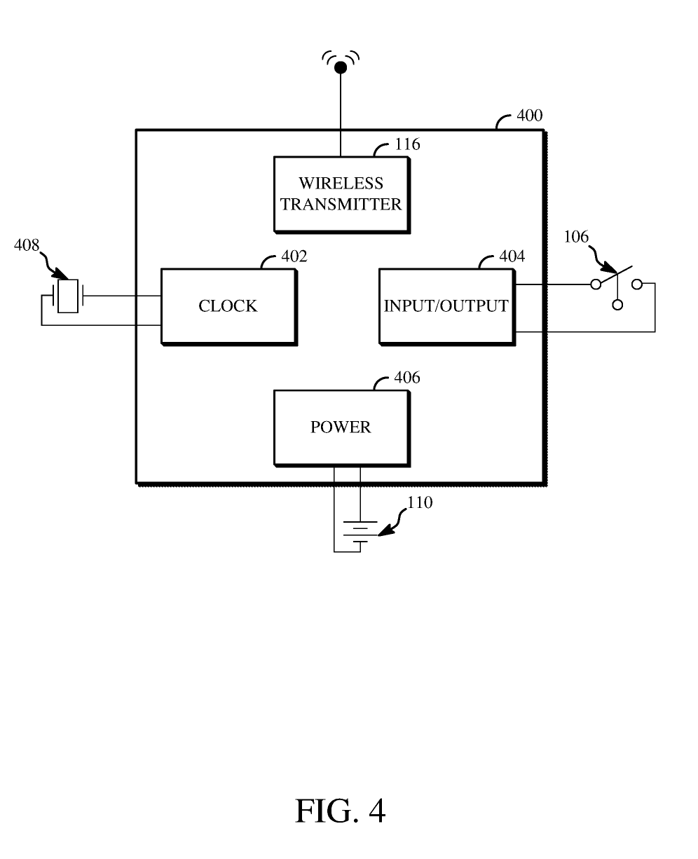

FIG. 4 is a block diagram of an example of a circuit of a microprocessor 400 of a wireless monitor. The microprocessor 400 includes a wireless transmitter 116, a clock element 402, an input/output element 404, and a power element 406. The microprocessor 400 can be included within the body 102 of a sensor device 100, for example, in place of the processor 112 and the wireless transmitter 116. Implementations of the wireless transmitter 116 are discussed above with respect to FIG. 1. In some implementations, the microprocessor 400 does not include the wireless transmitter 116, such that the microprocessor 400 is included within the body 102 of the sensor device 100 in place of the processor 112 alone.

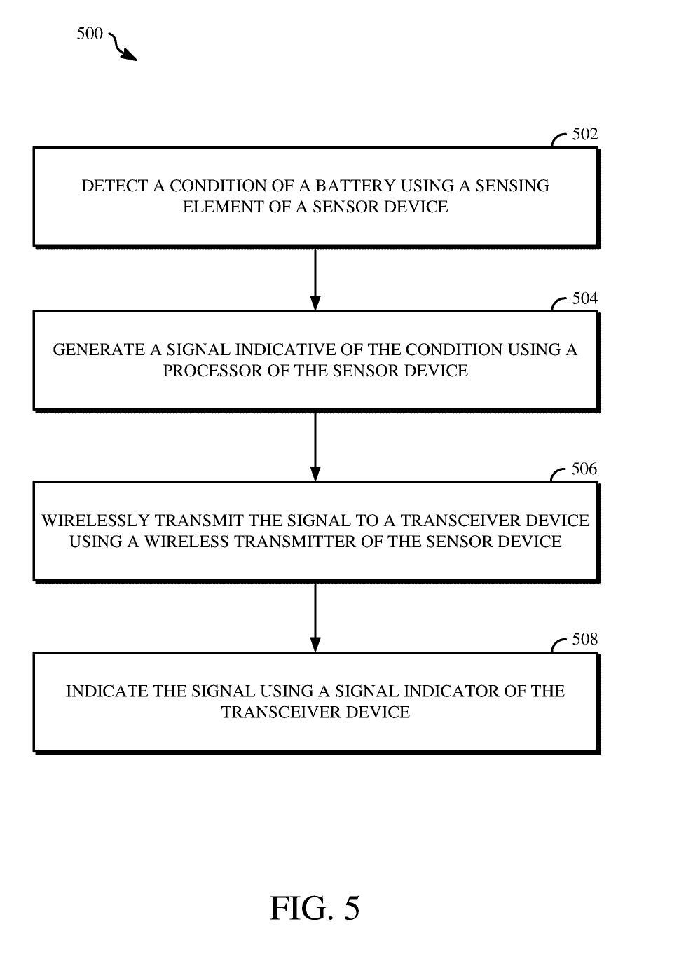

The clock element 402 generates a clock signal 408. The clock signal 408 can be a 32.7 kHz signal for timing the placement of the sensor device 100 in a wait state to conserve power. Implementations for configuring this wait statement placement timing are discussed below with respect to FIG. 5. The input/output element 404 is used to detect a condition of a battery to which the sensor device 100 including the microprocessor 400 is coupled, and generates a signal indicative of the detected condition. The input/output element 404 receives information from a sensing element 106 to indicate whether to generate a signal. For example, where the sensing element 106 is a contact closure probe, the input/output element can receive information indicating to generate a signal where the contact closure probe cannot conduct through a solution of the battery due to a volume of the solution. The power element 406 obtains power for the microprocessor 400 from a power source, such as the power source 110. For example, the power element 406 can include leads connecting to a 3V coin battery.

FIG. 5 is a flowchart illustrating an example of a method 500 for detecting a condition of a battery using a wireless monitor. In some implementations, the operations described with respect to the method 500 can be performed using one or more devices, for example, the sensor device 100 or transceiver device 200 of FIGS. 1 and 2, respectively. In some implementations, the operations described with respect to the method 500 can be implemented within a computer memory in the form of a non-transitory computer readable storage medium including program instructions executable by one or more processors that, when executed, cause the one or more processors to perform the operations. For example, instructions stored in the memory 114 of the sensor device 100 can be executed by the processor 112 of the sensor device 100 to perform one or more operations described with respect to the method 500. In another example, instructions stored in the memory 212 of the transceiver device 200 can be executed by the processor 210 of the transceiver device 200 to perform one or more operations described with respect to the method 500.

A condition of a battery is detected at operation 502. The detection can be by a sensing element of a sensor device, which sensing element contacts at least a portion of the battery to which the sensor device is coupled. In some implementations, the sensing element can be at least one of a contact closure probe, a temperature sensor, an accelerometer, a gravity sensor, or a cell voltage sensor. In some implementations, the contacting of the portion of the battery by the sensing element can be facilitated by the coupling of the sensor device to the battery. For example, the sensor device can be coupled to a port of the battery such that the sensing element can be disposed within a chamber internal to the battery. In some implementations, the contacting of the portion of the battery by the sensing element can be indirect via some other portion of the sensor device. For example, the sensing element can be disposed within a body of the sensor device.

In some implementations, the detection of a condition can occur based on measurements generated, calculated, or otherwise determined by the sensing element with respect to the battery. For example, where the sensing element is a contact closure probe and the condition is a condition indicative of a volume of solution within the battery, the detection can occur based on the sensing element moving along a shaft of the sensor device to a point indicating that the volume is at or below a minimum safe level. For example, the sensing element can float at or near a top of the volume of solution within a chamber of the battery, such that the sensing element floats lower within the chamber when the volume decreases. Upon the sensing element reaches a floating level corresponding to the minimum safe volume level, the condition indicating the low volume level of the solution can be detected by the sensor device. In another example, where the sensing element is a temperature sensor and the condition is a condition indicative of a temperature of the battery, the sensor device can detect the condition upon the temperature sensor measuring a temperature of the battery that meets or exceeds a maximum safe temperature at which the battery can operate.

A signal indicative of the detected condition is generated at 504. In some implementations, the signal can be generated by a processor of the sensor device. The signal includes data that can be transmitted wirelessly between electronic devices (e.g., a sensor device and a transceiver device). In some implementations, the signal can include data indicating one or more of the type of the condition (e.g., temperature, motion, etc.), an identifier of the sensor device that detected the condition (e.g., a character string, which may be random, user-configured, or otherwise), a date or time at which the detection occurred, or other data as may be useful for monitoring the operation of the battery for maintenance purposes. The signal is wirelessly transmitted from the sensor device to the transceiver device at 506. In some implementations, the transmission of the signal can be between a wireless transmitter of the sensor device, which sends, and a communication component of the transceiver device, which receives, the signal. The wireless transmission of the signal can occur over any suitable network or other wireless connection protocol or method.

The signal is indicated by the transceiver device at 508 responsive to receiving the signal from the sensor device. The transceiver device can include a signal indicator that indicates the signal upon receipt by the transceiver device. In some implementations, the signal indicator can indicate the signal using one or more of a light source or a sound source, for example, by blinking or flashing a light or emitting a steady or interrupted noise. In some implementations, the manner in which the signal indicator indicates a particular signal can depend upon an indicator configuration associated with the condition of the signal. For example, a user of the wireless monitor can define a number of indicator configurations for the signal indicator to use to separately identify different types of conditions detectable by the sensor device. The signal can therefore be indicated at 508 using the particular indicator configurations associated with the condition detected at 502

Configurations of the method 500 other than those described above are also possible. For example, in some implementations, the method 500 can include an operation to generate record data pertaining to at least one of the condition or the signal itself. In another example, in some implementations, the method 500 can include an operation to configure the sensor device to enter and exist a wait state periodically to listen for conditions detected by the sensing element thereof. For example, the operation can include setting a wake timer for a temporal delay, such as fifteen seconds, which can cause the sensor device to exit a wait state (e.g., an ultra-low power sleep state) after the specified time. The operation of the sensor device can thus include placing the sensor device in the wait state periodically or from time to time to preserve the power source thereof. Once the sensor device exists the wait state, the sensing element thereof can be directed (e.g., by the processor of the sensor device) to take measurement data corresponding to the implementation of the sensing element. The measurement data can be used to detect whether a condition of the battery exists. After a signal is transmitted therefrom, or after the sensing element determines that no signal is to be transmitted, the sensor device can return to the wait state. The operation can further include configuring the sensor device to repeat the foregoing sub-operations while the sensor device remains coupled to the battery, or until the power source of the sensor device has been exhausted.

The implementations of this disclosure can be implemented using a general purpose computer/processor with a computer program that, when executed, carries out at least a portion of the respective methods, techniques, algorithms, or instructions described herein. In addition, or alternatively, for example, a special purpose computer/processor can be utilized, which can contain specialized hardware for carrying out at least a portion of the methods, techniques, algorithms, or instructions described herein.

The particular implementations shown and described herein are illustrative examples of this disclosure and are not intended to otherwise limit the scope of this disclosure in any way. For the sake of brevity, conventional electronics, control systems, software development and other functional aspects of the systems (and components of the individual operating components of the systems) cannot be described in detail. Furthermore, the connecting lines, or connectors shown in the various figures presented are intended to represent example functional relationships or physical or logical couplings between the various elements. Many alternative or additional functional relationships, physical connections or logical connections can be present in a practical device.

The use of the terms “including,” “comprising,” “having,” or variations thereof herein is meant to encompass the items listed thereafter and equivalents thereof as well as additional items. Unless specified or limited otherwise, the terms “mounted,” “connected,” “supported,” “coupled,” or variations thereof are used broadly and encompass both direct and indirect mountings, connections, supports, and couplings. Further, “connected” and “coupled” are not restricted to physical or mechanical connections or couplings.

The use of the terms “a,” “an,” “the,” or similar referents in the context of describing the implementations of this disclosure (especially in the context of the following claims) should be construed to cover both the singular and the plural. Furthermore, unless otherwise indicated herein, the recitation of ranges of values herein is merely intended to serve as a shorthand alternative to referring individually to respective separate values falling within the range, and respective separate values are incorporated into the specification as if individually recited herein. Finally, the operations of any methods, techniques, algorithms, or instructions described herein are performable in any suitable order unless clearly indicated otherwise by the context. The use of an example, or language suggesting that an example is being described (e.g., “such as”), provided herein is intended merely to better illuminate the implementations of this disclosure and does not pose a limitation on the scope of this disclosure unless otherwise claimed.

All references, including publications, patent applications, and patents, cited herein are hereby incorporated by reference to the same extent as if the references were individually and specifically indicated as incorporated by reference and were set forth in its entirety herein.

The above-described implementations have been described in order to facilitate easy understanding of this disclosure, and such descriptions of such implementations do not limit this disclosure. To the contrary, the implementations of this disclosure are intended to cover various modifications and equivalent arrangements included within the scope of the appended claims, which scope is to be accorded the broadest interpretation as is permitted by law so as to encompass such modifications and equivalent arrangements.

What is claimed is:

1. A wireless monitor for detecting and indicating conditions of a battery, the wireless monitor comprising:
a sensor device coupled to the battery, the sensor device including a sensing element that detects a condition of the battery and a wireless transmitter that wirelessly transmits a signal indicative of the condition; and
a transceiver device in communication with the wireless transmitter of the sensor device, the transceiver device including a signal indicator that indicates the signal indicative of the condition responsive to receiving the signal from the wireless transmitter of the sensor device.

2. The wireless monitor of claim 1, wherein the sensing element is a contact closure probe and the condition is indicative of a volume of a solution of the battery.

3. The wireless monitor of claim 1, wherein the sensing element is a temperature sensor and the condition is indicative of a temperature of the battery.

4. The wireless monitor of claim 1, wherein the sensing element is an accelerometer and the condition is indicative of a motion of the battery.

5. The wireless monitor of claim 1, wherein at least a portion of the sensor device is removably coupled to a port of the battery.

6. The wireless monitor of claim 1, wherein at least a portion of the sensor device is permanently disposed within a chamber of the battery.

7. The wireless monitor of claim 1, wherein at least a portion of the sensor device is coupled to a sensor-specific mounting of the battery.

8. The wireless monitor of claim 1, wherein the signal indicator indicates the condition based on an indicator configuration associated with the condition.

9. The wireless monitor of claim 1, wherein the signal indicator includes at least one of a light source or a sound source.

10. The wireless monitor of claim 1, wherein record data is generated by at least one of the sensor device or the transceiver device, the record data pertaining to at least one of the condition or the signal.

11. A method for using a wireless monitor to detect and indicate conditions of a battery, the method comprising:
detecting a condition of a battery using a sensing element of a sensor device, the sensing element contacting at least a portion of the battery;
generating a signal indicative of the condition using a processor of the sensor device;
wirelessly transmitting the signal to a transceiver device using a wireless transmitter of the sensor device; and
indicating the signal using a signal indicator of the transceiver device.

12. The method of claim 11, wherein the signal indicator of the transceiver device indicates the signal based on an indicator configuration associated with the condition.

13. The method of claim 11, further comprising:
generating record data pertaining to at least one of the condition or the signal, wherein the generating of the record data is performed by one of the sensor device or the transceiver device.

14. The method of claim 11, wherein the signal indicator includes at least one of a light source or a sound source.

15. The method of claim 11, wherein the sensing element is a contact closure probe and the condition is indicative of a volume of a solution of the battery.

16. The method of claim 11, wherein the sensing element is a temperature sensor and the condition is indicative of a temperature of the battery.

17. The method of claim 11, wherein the sensing element is an accelerometer and the condition is indicative of a motion of the battery.

18. The method of claim 11, wherein at least a portion of the sensor device is removably coupled to a port of the battery.

19. The method of claim 11, wherein at least a portion of the sensor device is permanently disposed within a chamber of the battery.

20. A system for wirelessly monitoring conditions of batteries, the system comprising:
a battery including a chamber storing a volume of an electrolyte solution, wherein the battery is usable to power machinery;
a sensor device coupled to the battery, the sensor device including a body, an elongate shaft coupled to the body, at least one sensing element, and a wireless transmitter; and
a transceiver device including a communication component and at least one signal indicator,
wherein the wireless transmitter wirelessly transmits at least one of a first signal based on the volume of the electrolyte solution within the chamber of the battery, a second signal based on a temperature of the battery, or a third signal based on a motion of the battery,
wherein the at least one sensing element is at least one of a contact closure probe, a temperature sensor, or an accelerometer,
wherein the communication component is in communication with the wireless transmitter of the sensor device and receives at least one of the first signal, the second signal, or the third signal from the sensor device, and
wherein the at least one signal indicator indicates the at least one of the first signal, the second signal, or the third signal using at least one indicator configuration associated with the at least one of the first signal, the second signal, or the third signal.
